(19) United States
(12) Patent Application Publication
(10) Pub. No.: US 2024/0310530 A1
(43) Pub. Date: Sep. 19, 2024

(54) Contactless safeguarding of a machine

(71) Applicant: SICK AG, Waldkirch (DE)

(72) Inventors: Markus HAMMES, Waldkirch (DE); Christoph HOFMANN, Waldkirch (DE)

(21) Appl. No.: 18/603,450

(22) Filed: Mar. 13, 2024

(30) Foreign Application Priority Data
Mar. 15, 2023 (EP) 23162023.8

(51) Int. Cl. G01S 17/894; F16P 3/14; G01S 7/48; G01S 17/58

(52) U.S. Cl. CPC G01S 17/894; F16P 3/144; G01S 7/4802; G01S 17/58

(57) ABSTRACT

A method of a contactless safeguarding of a machine is provided in which a plurality of protected fields configured in the environment of the machine are monitored for protected field intrusions by at least one optoelectronic sensor and, on a protected field intrusion, a safe output signal is generated at a safe output associated with the protected field. The protected fields are configured such that a vehicle approaching the machine results in a different sequence of protected field intrusions than a person approaching the machine and the sequence of protected field intrusions is evaluated to distinguish the vehicle and the person from one another. Three-dimensional protected fields are monitored that have at least two layers, having a lower layer and an upper layer arranged thereabove; and in that the configuration of the protected fields in the lower layer differs from the configuration of the protected fields in the upper layer.

The invention relates to a method and to a monitoring device for a contactless safeguarding of a machine respectively.

Optoelectronic sensors are very frequently used in contactless monitoring for safeguarding hazards such as are represented by machines in an industrial environment. In this respect, the machine is blockaded by construction means in part, for instance by fences, and is safeguarded by an optoelectronic sensor such as a light grid in a remaining access zone. Alternatively to a light grid, a laser scanner having protected field monitoring can be used. A protected field is a configured partial zone of the scanned zone that may not be entered by operators during the operation of the machine. If an unauthorized protected field intrusion is recognized, for instance a leg of an operator, the machine is switched to a safe state by outputting a safety related signal at a safe output (OSSD, output signal switching device). Sensors used in safety technology have to work particularly reliably and must therefore satisfy high safety demands, for example the EN13849 standard for safety of machinery and the machinery standard EN61496 for electrosensitive protective equipment (ESPE). To satisfy these safety standards, a series of measures have to be taken such as a secure electronic evaluation by redundant, diverse electronics or different functional monitoring processes, especially the monitoring of the contamination of optical components, including a front screen.

There is a particular challenge if access to the safeguarded machine is repeatedly required in regular operation. Examples include robot cells in which industrial robots take over production or logistics steps that have to be supported at points. It is here, for example, the supply or collection of material. In practice, such zones are still safeguarded as a rule by fences and light grids. A person who enters the zone of the machine is recognized and the machine is thereupon switched off. Once the supporting worksteps on the machine have been completed and the machine zone has been left, a manual restart is required in that, for example, the person actuates a button attached outside the safeguarded zone. This is necessary because the sensors cannot safety recognize whether the person has actually left again. A light grid only recognizes the passing through itself, but cannot decide the side on which the person is subsequently located. The protected field of a laser scanner cannot always cover the entire zone in front of the machine, for example because otherwise the machine would trigger the protected field in operation. In addition, the person could climb onto a fixed objects such as a stand of the machine and could thus become invisible to the laser scanner. A person must therefore be responsible for the machine not endangering anyone on the restart.

This laborious procedure that has effects on productivity cannot even be resolved by an autonomous vehicle for material supply since the vehicle also infringes the protected field so that the machine is switched off. This would not be objectively required because no person is at risk. In addition, there is still a need for the presence of a person for the restart. Under certain circumstances, the machine will have to wait to continue working until a person has come to release the restart.

In the meantime, safe 3D sensor have become available for a three-dimensional protected field evaluation. An example for this is a 3D camera that measures a distance and thereby acquires depth information. The detected three-dimensional image data having spacing values or distance values for the individual pixels are also called a 3D image, a distance image, or a depth map. There are 3D cameras in different technologies, including a time of flight process, a stereoscopic process, and a projection process, or plenoptic cameras. A scene is illuminated by amplitude-modulated light in a time of flight (TOF) camera looked at in somewhat more detail The light returning from the scene is received and is demodulated using the same frequency that is also used for the modulation of the transmitted light (lock-in process). A measured amplitude value results from the demodulation that corresponds to a sampling value of the received signal. At least two sampling values are required for the phase determination of a periodic signal in accordance with the Nyquist criterion. The measurement is therefore carried out using different relative phasings between the signals for the modulation at the transmission side and the demodulation at the reception side. The absolute phase shift between the transmitted signal and the received signal can thus be determined that is caused by the time of flight and this is in turn proportional to the object distance in the scene. Three-dimensional monitoring does not, however, per se already solve the described problem. Safe algorithms that have proven themselves in practice and that recognize persons in the vicinity of the machine selectively and reliably are not yet available and at least require a high development effort and particularly powerful hardware.

Safety laser scanners and safety cameras have furthermore become known in recent times that simultaneously evaluate a plurality of protected fields. This provides a requirement for new applications, but does not per se solve the described problem, just as little as a three-dimensional protected field. In addition, the simultaneous evaluation is very processing intensive and only an extremely limited number of simultaneously evaluated protected fields is provided.

EP 3 153 885 A1 discloses a piece of optoelectronic protective equipment that monitors which of a plurality of protected zones has been infringed by an object (protected zone infringement) and which protected zone the object has left (protected zone release). The plant operation is automatically released on a predetermined order of protected zone infringements and protected zone releases. The machine is thus, however, still at least temporarily shut down without distinction by the approach of a person and of an automatic vehicle.

A device for safeguarding a hazardous zone of a plant is presented in EP 3 575 666 A1 that monitors a protected zone adapted to the hazardous zone. The movement routine of the object on the departure from the protected zone is detected and, on registration of a valid movement routine, a release signal is generated that activates the hazardous operation of the plant again. In an embodiment, a valid movement routine that can only be generated by a vehicle, but not by other objects or by a person, is defined by means of a plurality of partial zones of the protected zone. This classification of vehicles and persons, however, remains insufficiently distinctive.

An access safeguarding system is known from EP 3 425 256 A1 that monitors a protected field with a first optoelectronic sensor and a contour recognition field with a second optoelectronic sensor arranged upstream. If the full width of the contour recognition field is interrupted, the safety function of the protected field is suppressed. This is only possible with a vehicle such as a forklift truck due to the dimensions; a person would be too small for this. This kind of distinction between a person and a vehicle thus does not work for smaller vehicles such as are customary in logistics.

EP 3 470 879 A1 configures at least partially mutually overlapping monitored fields in a laser scanner. Monitored segments are thereby produced that differ from one another by which monitored fields overlap there. The number of monitored fields provided at the hardware side is thus refined to the monitored segments. However, the document does not look at a classification of intruding objects or a restart.

It is therefore the object of the invention to achieve an improved differentiated safeguarding.

This object is satisfied by a method and by a monitoring device for a contactless safeguarding of a machine in accordance with the respective independent claim. The machine is, for example, a robot or a machining tool that has to be traveled to again and again by the vehicle in operation, for instance to supply parts or to collect machined parts. The machine forms a hazardous zone since accidents with personal injury can occur by its operation. Safeguarding means that such situations are avoided by a timely action on the machine.

For this purpose, at least one optoelectronic sensor monitors a plurality of protected fields in the environment of the machine. Protected fields are, as customary, configured partial zones of the monitored zone of the sensor that are monitored for the penetration of objects, which is then called a protected field intrusion. The name protected field has a historical origin. As will become clearer below, three-dimensional spatial zones are configured and monitored as protected fields in accordance with the invention. The protected fields are simultaneously monitored, either by a parallel protected field evaluation or by a sequential protected field evaluation in cycles below the response time, which is then still simultaneous for all practical purposes and within the framework of the safety demands.

The optoelectronic sensor is preferably a safety sensor and the protected field evaluations and the evaluations of protected field interventions relevant to the safeguarding and to the subsequent release that are still to follow are preferably safe evaluations. Safe and safety mean, as in the total description, that measures are taken to control errors up to a specific safety level or to observe regulations of a relevant safety standard for machine safety or for electrosensitive protective equipment, of which some have been named in the introduction. Non-safe is the opposite of safe and accordingly said demands on failsafeness are not satisfied for non-safe devices, transmission paths, evaluations, and the like.

A recognized protected field intrusion, also called a protected field infringement, is reported to a safe output of the sensor, and indeed in a manner in which it remains recognizable which of the plurality of protected fields were infringed. A safe output (OSSD, output signal switching device) can, for example, be provided for this purpose for each one of the plurality of protected fields. Instead of respective separate connections, the safe signals for an associated protected field infringement that can be associated with a protected field can, however, also be implemented as bits or the like of a more complex safe output.

The protected fields are configured such that a vehicle approaching the machine triggers a different sequence of protected field intrusions than a person approaching the machine. A distinction can thus be made whether a vehicle or a person approaches the machine by a comparison of the detected sequence of protected field intrusions with a sequence expected for a vehicle or for a person.

The invention starts from the basic idea of monitoring three-dimensional protected fields by the optoelectronic sensor and utilizing the additional flexibility of the configuration of protected fields thus provided to recognize an approaching vehicle as such. The optoelectronic sensor is, for example, a 3D camera, in particular a time of flight camera, a multilayer laser scanner, or a 3D LiDAR. The protected fields are configured and evaluated in two layers, a lower layer preferably close to the ground and an upper layer arranged thereabove. The protected field configurations in the two layers differ from one another. A horizontal 2D section through the upper layer thus delivers a different image of the protected fields than a horizontal 2D section through the lower layer. It first relates to the entire protected field configuration; a single protected field or a plurality of protected fields can by all means be configured the same in both layers and the difference can also comprise at least one protected field only being provided in one layer at all and not in the other layer. The protected fields are preferably the same over the height within a respective layer to simplify the configuration; 2D sections through the protected fields of a layer and in parallel with the dividing plane of the layers are then identical to one another.

An approach in the lower layer or close to the floor thus generates a different sequence of protected field intrusions than an approach in the upper layer. It must be noted here that no exclusive approach is possible in the upper layer for a person and for any other object, except for a flying object such as a drone, but only simultaneously in the lower and upper layers. A vehicle of a height that remains in the lower layer and that can thus be distinguished from a person walking upright, who also triggers protected field intrusions in the upper layer, with reference to the sequence of the protected field intrusions. A person could still approach in a crawling manner. This case is, however, at best relevant to the highest safety levels in view of the non-visible protected fields that a crawling person would nevertheless have to avoid. In addition, a crawl-under protection is likewise possible in embodiments still to be explained below by further demands on the protected field configuration.

The protected fields can be configured in more than two layers, for example a bottommost layer for an undercarriage, a middle layer for the remainder of a vehicle, and an upper layer for a walking person. A distinction between permitted and unpermitted vehicles could thus then be made, for example. There are preferably two layers in order not to make the configuration and evaluation unnecessarily complex.

The method is a computer implemented method that runs, for example, in a processing unit of the optoelectronic sensor and/or a connected processing unit. The configuration of the protected fields is preceded by the contactless safeguarding; it typically takes place manually by a safety expert due to the complex safety aspects to be observed. In this respect, however, automatic aids are possible such as proposals for protected fields and a configuration program having graphical support, similar to a CAD program, for example, by which geometrical objects as parts of protected fields can be fit into images of the environment of the machine.

The invention has the advantage that a safe distinguishability is made possible between an approaching person and an approaching vehicle. It simultaneously provides a basis for an automatic restart of the machine after a vehicle has approached and has departed again. Both are of very high significance for the productivity of the machine. In this respect, the invention can be implemented using available technology. No new, highly complex image evaluations have to be developed that selectively recognize a person. The distinction in accordance with the invention is rather based on the proven and existing safe protected field evaluation.

The machine is preferably safeguarded on a recognition of a person approaching the machine. The sequence of protected field intrusions therefore does not correspond to those for a vehicle that only travels through the protected fields of the lower layer and who may preferably approach the machine without safeguarding, with an adaptation of the behavior of the machine at least also being conceivable with an approaching vehicle. Depending on the application, safeguarding means an appropriate response that precludes an accident. It can be a deceleration of the machine, an evasion, or a change of the further work routine up to an immediate stopping or switching into a safe state.

Only two protected fields, that in particular have partial protected fields, are preferably monitored. In the following, the two protected fields will also be called protected field A and protected field B and the associated safe output signals that indicate a protected field intrusion, are called OSSD A and OSSD B. In this embodiment, the ability of the optoelectronic sensor to only monitor two protected fields simultaneously is sufficient. At first glance, this appears to be easily not sufficient to distinguish persons and vehicles since there are only four states, namely no protected field infringed, one of the protected fields A or B infringed, or both protected fields A and B infringed. The protected fields, however, preferably permit almost any desired complex geometry. This can include partial protected fields in one of the protected fields or in both partial protected fields, that is non-contiguous partial zones of a protected field in, in principle, any desired number, that can be as small as desired within the framework of the resolution capability of the optoelectronic sensor. A contiguous protected field can in another respect, viewed in only one of the layers, also degrade into non-contiguous partial protected fields such as can be illustrated by a comb-like structure over both layers. A plurality of partial protected fields of a protected field differ clearly from a plurality of protected fields since in the partial protected fields a protected field intrusion is only associated with the common protected field, without the information which partial protected field has triggered the protected field intrusion. This information can, however, be acquired in accordance with the invention by a downstream evaluation using the sequence of protected field intrusions, thus the time behavior or time patterns.

The two protected fields are preferably monitored for protected field intrusions by a respective one separate optoelectronic sensor. Optoelectronic sensors are sufficient for this purpose that can each only monitor a single protected field or their ability for the simultaneous protected field monitoring is not utilized. A higher safety level is achieved by the redundancy of the sensors.

The protected fields are preferably configured such that on an approach of an object in the lower layer, initially a different protected field is first infringed than in the upper layer. The first protected field intrusion of an approach movement thus already indicates a person or a vehicle. In the case of a protected field intrusion in the upper layer, a safeguarding can preferably take place immediately. It is immediately clear that this cannot be a permitted vehicle. This corresponds to the conventional function of a protected field. A protected field intrusion in the lower layer is, in contrast to a vehicle approaching the machine, preferably only indicative; further evaluations of the coming sequence of protected field intrusions are then necessary for a safe decision until the vehicle has arrived in front of the machine.

Only one protected field, in particular without partial protected fields, is preferably configured in the upper layer. The classical safeguarding function can thus already be implemented for the upper layer. The sequence of the protected field intrusions reverts to the simplest case, namely a purely binary piece of information whether the protected field in the upper layer has been infringed or not. In the lower layer, in contrast, protected fields and/or partial protected fields are preferably configured with more complex geometries that generate a varying sequence in the sense of changing protected field intrusions on an approach of a vehicle.

In the lower layer, two protected fields or partial protected fields of the two protected fields are preferably configured such that the two protected fields or partial protected fields alternate with one another in a direction of an approach to the machine. Due to the three-dimensional protected fields, three directions or dimensions have to be distinguished: a height direction in which the upper layer is arranged above the lower layer and the direction of the approach within a plane of the same height, and a direction transverse thereto. An approach movement in the lower layer triggers a sequence ABAB . . . of the protected field intrusions in this embodiment.

The alternating protected fields or partial protected fields overlap one another, preferably partially. A sequence . . . A AB B . . . thus result on an approach movement in the lower layer. The interim infringement of the two protected fields on the basis of the overlap makes it possible to recognize a change of direction. A respective free zone is preferably arranged between the alternating protected fields or partial protected fields. A gap thus arises in the sequence, for example . . . A (blank) . . . B (blank) . . . The overlap and the free zone are particularly preferably accumulated, with a sequence such as . . . A AB B (blank) A AB . . . The free zone can be as large as a partial protected field and/or their mutual overlap. A different preferable extent of the free zone is measured by whether a permitted vehicle fits without triggering a protected field, corresponding to a vehicle length of, for example, 0.5 m to 2 m. The overlap region can be as large as the free zone; but the actual demand here is only that both overlapping protected fields are reliably triggered on a penetration into the overlap zone. A smaller extent of, for example, 20 cm is sufficient for this.

In the lower layer, a plurality of protected fields or partial protected fields are preferably configured transversely to a direction of an approach of the machine. This now relates to a lateral direction or transverse direction, the third direction after a height direction and a direction of an approach to the machine. It is here possible to differentiate further, for instance to check certain vehicle contours or to form different corridors. There can, for example, be a left corridor with a sequence . . . ABAB . . . and a right corridor with a sequence . . . BABA . . . of protected field intrusions on an approach through the respective corridor.

At least one free zone between the protected fields or partial protected fields of the protected fields of the lower layer is preferably so small in its lateral extension such that a lying or crawling person does not fully have space therein. The already mentioned crawl-under protection is thus implemented. The lateral extent of the free space is adapted to a permitted vehicle. A break while the vehicle is in the free zone and does not infringe any protected field thereby results in the sequence of protected field intrusions on an approach of a vehicle. If a person should attempt to imitate the permitted sequence of protected field intrusions of a vehicle by crawling or even rolling on the floor, this is not successful because the person does not fit into the free space and therefore does infringe a protected field in at least one of the three possible directions.

A direction of movement is preferably determined from the sequence of protected field intrusions. Depending on the protected field configuration, it is possibly only possible for field intrusions by the person in the upper layer change the sequence. An approach of a person should, however, preferably anyway not be permitted, but rather only the vehicle may enter into the proximity of the working machine, while there is safeguarding for a person. However, the recognition of a direction of movement in the upper layer is also possible by more complex protected field configurations. The recognition of a direction of movement is particularly reliable in the above-indicated protected field configuration with a mutual overlap and free space. On a sequence . . . A AB B (blank) . . . the direction of movement is forward toward the machine and, on a sequence . . . B AB A (blank) . . . correspondingly backward away from the machine, or vice versa.

A counter is preferably counted up and down on a protected field intrusion or on an ending protected field intrusion corresponding to the direction of movement and a position is determined from the status of the counter. A protected field intrusion means that an object has penetrated, an ending protected field engagement, correspondingly means the object has again departed from the protected field. Which partial protected field is affected can be differentiated via the counter with a plurality of partial protected fields. The position can thus be detected incrementally using the counter with knowledge of the respective direction of movement. In this respect, the count per se can already be interpreted as a position or a real position is calculated from the count and the protected field geometry.

The two protected fields or their partial protected fields preferably each form a code track. An analogy to incremental encoders should thus be established. With an incremental encoder, two mutually offset code tracks are scanned and the pulse pattern that arises in the scan signals is evaluated to acquire an incremental position. The protected fields or their partial protected fields and the gaps correspondingly encode for one and zero. The scanning of this special code track takes place in that a moving object enters and again departs from a protected field or a partial protected field and thus generates corresponding sequences of protected field intrusions in the associated safe output signals. Alternative and more complex code tracks can be imitated as a simple alternation, with . . . ABBABAAB . . . only being one of innumerable further examples. It is furthermore conceivable to add at least one further protected field C, D . . . and thus to form more powerful codes. This is all known per se, for example from rotary encoders, is therefore not described in detail here, but rather for the simple representative example . . . ABABABA . . .

The sequence of protected field intrusions is preferably evaluated using an incremental encoder process for the evaluation of the scan signals of two mutually offset code tracks of a standard. The analogy with an incremental encoder is thus not only established in the code tracks, but also in their evaluation. The time extent of the safe output signals corresponding to the sequence of protected field intrusions is treated as the scan signals of an incremental encoder. The total powerful arsenal of encodings and evaluations is thus available that has been developed for incremental encoders so that it is known per se and can be used in accordance with the invention without explaining it in detail here.

After a protected field intrusion, the protected fields in the lower layer are preferably displaced along a direction of an approach to the machine. This is an alternative procedure of determining a position from a fixed protected field configuration. Any associated partial protected fields are equally displaced with the protected fields. A free zone is in particular also displaced toward the machine with the vehicle, with the vehicle advancing over and over again into the protected field disposed in front of the free zone and triggering a repeat displacement by this protected field intrusion. A counter can register the number of displacements in order thus to respectively determine the current position incrementally. The displacement can be achieved by switching over into a protected field configuration with an offset arrangement of the protected fields. Some few protected field configurations that repeat cyclically are sufficient. The vehicle is no longer in the same free zone, but rather in an adjacent free zone after such a cycle. It is possible to distinguish between a forward movement and a backward movement by two alternating protected fields. A counter is counted up or down with the displacements or switchovers depending on the direction of movement.

When a vehicle is at the machine, a switchover to protected fields is preferably made that safeguard the machine and do not permit any further vehicle in the vicinity of the machine. The approach of the vehicle is terminated in this state and the cooperation at the vehicle and machine is carried out; for example, material or a workpiece is unloaded, loaded, or processed by a robot. The environment with the switched over protected fields is safeguarded during such worksteps of the machine so that no person and, where possible, no other vehicle also approaches. If nevertheless a plurality of vehicles should be permitted at the machine, this can in particular be achieved with the above-mentioned protected field configuration with a plurality of protected fields or partial protected fields in a direction transversely to a direction of the approach or of a plurality of corridors. It is also possible by a corresponding protected field configuration to distinguish a plurality of zones in front of the machine so that work can be continued at full speed in a zone next to the vehicle.

The machine preferably restarts automatically if no protected field is present and it was recognized with reference to the preceding sequence of protected field intrusions that a vehicle or a person has departed from the zone of the protected fields. The vehicle was therefore at the machine and drives off again. This can be confirmed analogously to the recognition of the approach from the sequence of the protected field intrusions. It is then ensured that the environment of the machine is free again so that a restart can take place without the previously customary manual confirmation. With a sufficiently complex protected field configuration in the upper layer, the departure of a person is also safely determinable for the person who has triggered a safeguarding so that the safeguarding can be canceled and the machine can automatically restart.

A height of the lower layer is preferably adapted in dependence on an expected vehicle or on a load state of a vehicle. This height can also be defined by the height of a dividing plane between the lower layer and the upper layer. On an adaptation, the lower layer therefore increases or decreases in volume, so-to-say in its thickness, or it is displaced upward or downward and the upper layer is corresponding offset in its vertical position. The adaptation can, for example, be initiated in that certain vehicles of a height smaller than the new height of the lower layer should be permitted or in that the effective height of a vehicle changes in the course of a loading and unloading at the machine. The adaptation can be carried out by a new operating mode or dynamically. An additional sensor system is preferably provided that measures an effective height of a vehicle. Raw data of the optoelectronic sensor can be used for this purpose.

The monitoring device in accordance with the invention has at least a safe optoelectronic sensor and a safety controller connected to the optoelectronic sensor. Safety controller means a safe evaluation unit that is implemented on any desired hardware, in particular a safety controller as a controller permitted for safety applications in a narrower sense. The safe optoelectronic sensor comprises a light receiver that generates a received signal from received light from the monitored zone. Depending on the sensor, the received signal is, for example, the signal of a photodiode that receives a returning scan beam or image data of an image sensor are called a received signal in generalized terms. A monitoring of a plurality of protected fields configured in the environment of the machine for protected field intrusions takes place using the received signal in an evaluation unit of the sensor. On a protected field infringement, a safe output signal that is associated with the protected field is generated at a safe output of the sensor. For this purpose, the sensor has at least two safe outputs, in particular OSSDs, at which a respective binary safe output signal can be output. The two safe outputs are preferably separate physical connectors, but can also be implemented as a bit or the like of a more complex safety output. The protected field configuration and the evaluation of a sequence of protected field intrusions for distinguishing a vehicle approaching the machine and an approaching person are analogous to the method in accordance with the invention in one of the described embodiments.

The safe optoelectronic sensor is preferably a 3D camera, in particular a time of flight camera. A large monitored zone can thus be detected and the three-dimensional configuration and monitoring of protected fields and partial protected fields is possible in a fine grid. Alternatively to a 3D camera, a different 3D sensor can be used, for example a multiplayer laser scanner or a 3D LiDAR.

The invention will be explained in more detail in the following also with respect to further features and advantages by way of example with reference to embodiments and to the enclosed drawing. The Figures of the drawing show in:

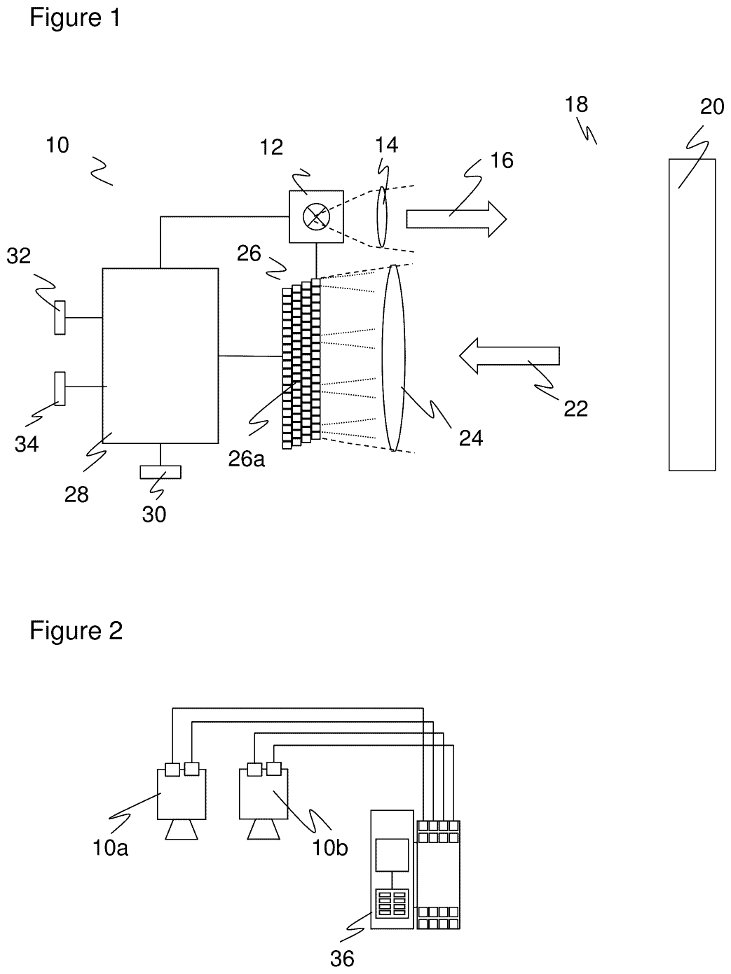

FIG. 1 a schematic block diagram of a 3D time of flight camera;

FIG. 2 a schematic representation of a monitoring device having two cameras and a safety controller;

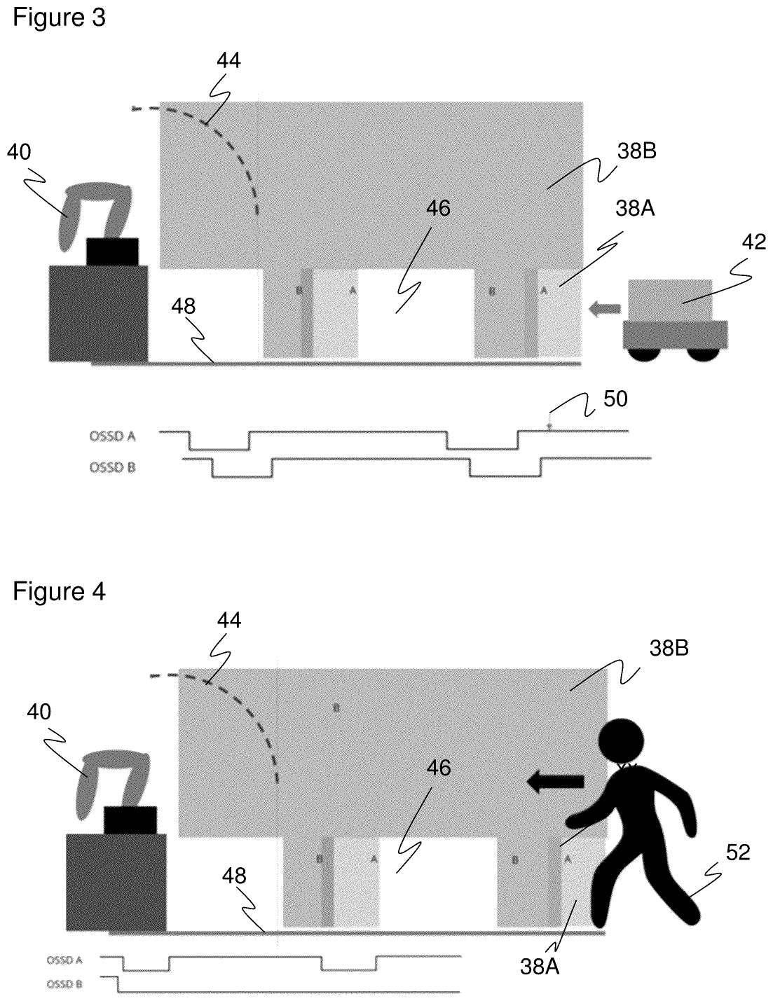

FIG. 3 a schematic representation of an exemplary protective field configuration with protected field intrusion with a vehicle approaching a machine to be safeguarded;

FIG. 4 a schematic representation of the protected field configuration in accordance with FIG. 3 with protected field intrusions with a person approaching the machine;

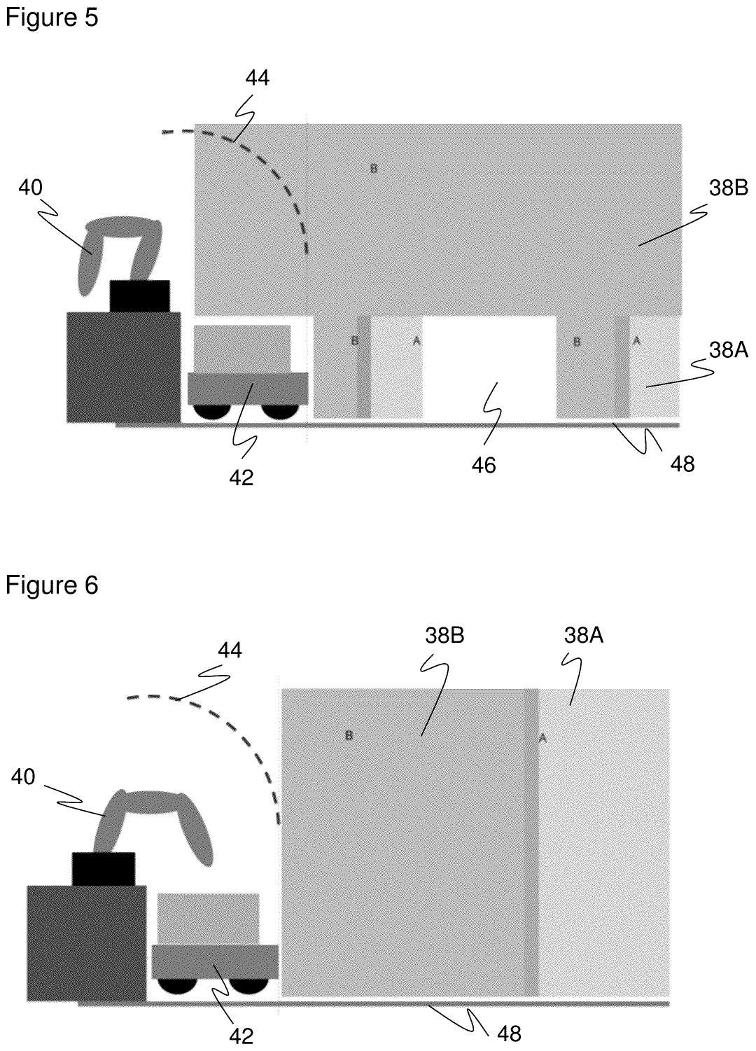

FIG. 5 a schematic representation of the protected field configuration in accordance with FIG. 3, with now the vehicle having reached the machine;

FIG. 6 a representation in which, in the situation of FIG. 5, a switch has been made to a new protected field configuration that safeguards a common workstep of the machine and of the vehicle;

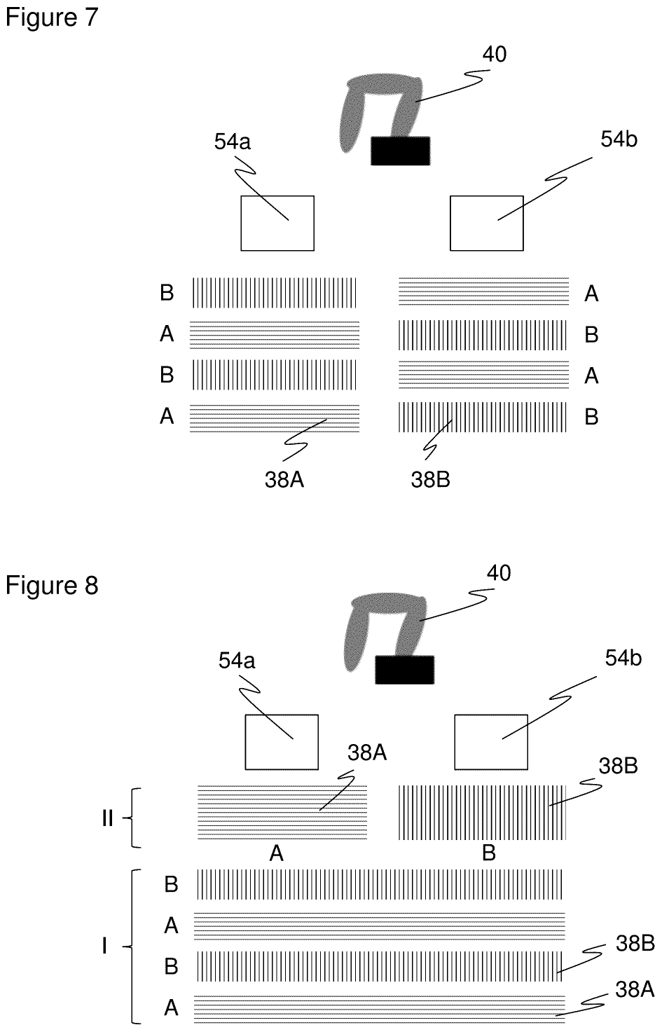

FIG. 7 a simplified representation of a protected field configuration with a plurality of corridors arranged next to one another;

FIG. 8 a simplified representation of a further protected field configuration with a switchover to a different protected field set on reaching the machine and two work zones monitored by different protected fields;

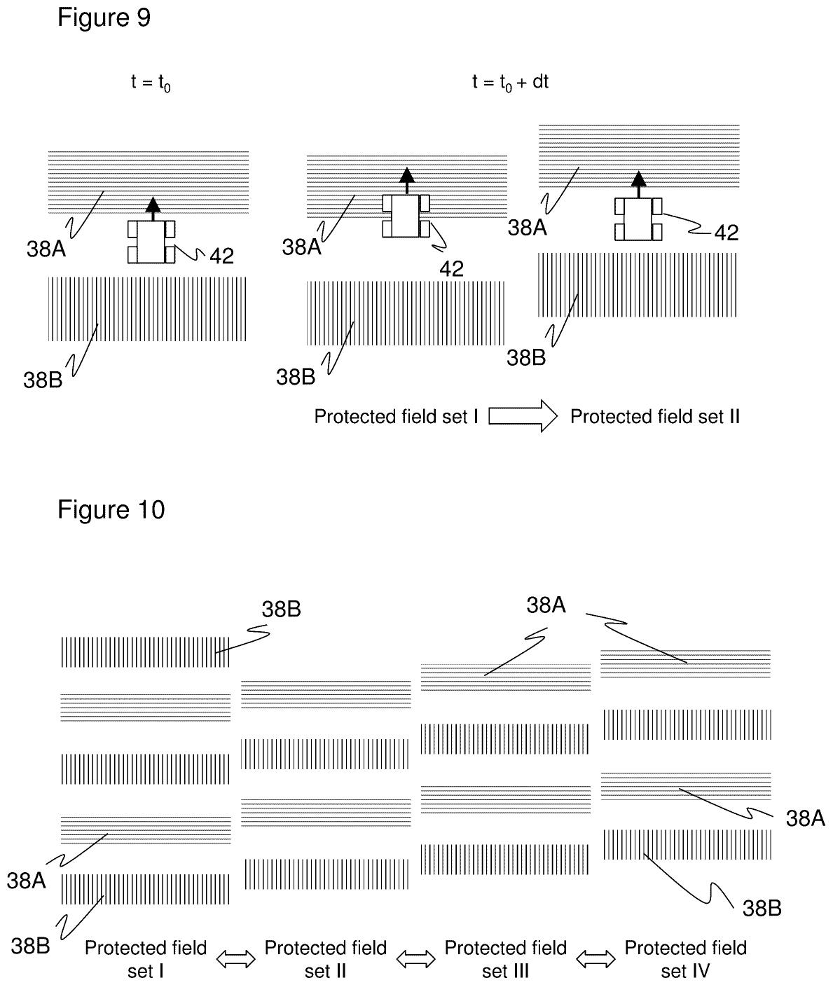

FIG. 9 a simplified representation of a further protected field configuration in which the protected fields are displaced or switched over with the vehicle movement;

FIG. 10 a schematic representation of four exemplary protected field sets between which there is a cyclic switchover on an object movement to implement the displacement in accordance with FIG. 9; and

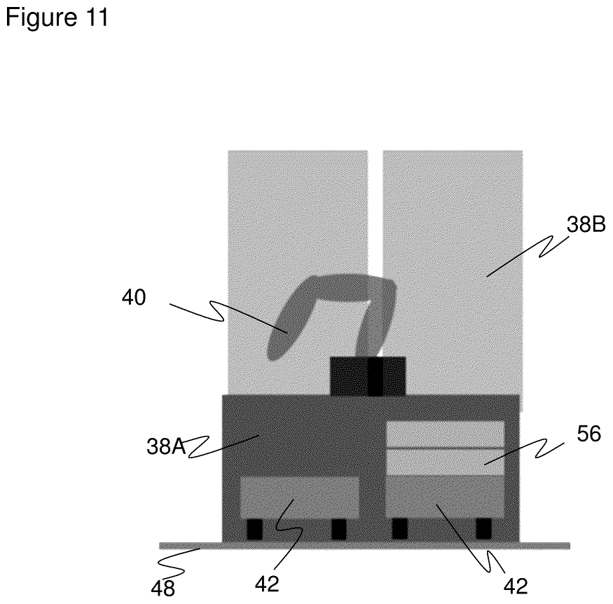

FIG. 11 a schematic representation of a further protected field configuration in which a switchover is made to another protected field set depending on the load state of the vehicle.

FIG. 1 shows a schematic block diagram of a camera 10 that is preferably configured as a 3D time of flight camera and that will be described as representative for an optoelectronic sensor that can be used in connection with the invention. An illumination unit 12 transmits transmitted light 16 modulated by a transmission optics 14 into a monitored zone 18. LEDs or lasers in the form of edge emitters or VCSELs can be considered as the light source. The illumination unit 12 is controllable such that the amplitude of the transmitted limit 16 is modulated at a frequency typically in the range of 1 MHz to 1000 MHz The modulation is, for example, sinusoidal or rectangular, at least a periodic modulation. A limited unambiguity range of the distance measurement is produced by the frequency so that smaller modulation frequencies are required for large ranges of the camera 10. Alternatively, measurements are carried out at two to three or more modulation frequencies to increase the unambiguity range in a combination of measurements.

When the transmitted light 16 is incident on an object 20 in the monitored zone 18, a portion is reflected back to the camera 10 as received light 22 and is guided there through a reception optics 24, for example a single lens or a reception objective, onto an image sensor 26. The image sensor 26 has a plurality of reception elements or reception pixels 26a arranged to form a matrix or a row, for example. The resolution of the image sensor 26 can extend from two or some few up to thousands or millions of reception pixels 26a. A demodulation corresponding to a lock-in process takes place therein. A plurality of sampling values from which ultimately the phase displacement between the transmitted light 16 and the received light 22, and thus the time of flight, can be measured are generated by repeated detection with a modulation of the transmitted light 16 respectively slightly displaced over the repetitions. The pixel arrangement is typically a matrix so that a lateral spatial resolution results in an X direction and in a Y direction results, which is supplemented by the Z direction of the distance measurement to form the three-dimensional image data. This 3D detection is preferably meant when a 3D camera, a 3D time of flight camera, or three-dimensional image data are spoken of. In principle, however, different pixel arrangements are also conceivable; for instance, a pixel row that is selected in a matrix or that forms the whole image sensor of a line scan camera.

At least one protected field is configured, preferably two or even more protected fields are configured, in a control and evaluation unit 28 having at least one digital processing module such as a microprocessor or the like. Protected fields are geometrical specifications for a partial zone of the monitored zone 18 that are configured or are fed in via an interface 30, for example in a CAD program or in any other manner by means of the control and evaluation unit 28. The protected fields are monitored for object intrusions and, on a protected field infringement, a safe output signal is output at a safe output 32, 34 associated with the protected field. The status of the safe output accordingly binarily reflects the presence or absence of an object in the associated protected field. In embodiments having two protected fields, the protected fields are repeatedly called protected fields A and B in the following; the associated safe output 32, 34 accordingly OSSD A and OSSD B. The camera 10 and in particular the protected field evaluation together with the output signals or OSSD states are safe in the sense defined in the introduction.

FIG. 2 shows a schematic representation of a monitoring device having two cameras 10a-b and a safety controller 36. In an alternative embodiment, only one camera is provided, with other optoelectronic sensor also being possible, in particular 3D cameras in accordance with a different principle such as stereoscopy or a projection process or light sectioning process, but also a multilayer laser scanner or a 3D LiDAR. The evaluation of the protected field intrusions now to be described takes place in a safety controller 36, with this first generally to be understood as a safe evaluation of a processing unit on any desired hardware and only preferably as a safety controller in the narrower sense. The safety controller 36 evaluates the sequence of the protected field intrusions. If a hazard is recognized, a safety related signal is output to a monitored machine or to a robot. The machine or robot thereupon becomes slower or diverges to worksteps that can at least not be a hazard with this recognized object movement and the machine is only switched to a safe state in case of an emergency. High availability and productivity are thus achieved overall. If the safety controller 36 recognizes with reference to the sequence of protected field intrusions that it is a permitted vehicle that approaches and not a person, no safeguarding takes place or only a milder safeguarding such as a deceleration. The approach to the machine should be permitted to the vehicle to there carry out a common workstep of the machine and the vehicle, in particular a loading or unloading procedure or a machining at a workpiece on the vehicle.

FIG. 3 shows a schematic representation of an exemplary protected field configuration with a preferred number of two protected fields 38A-B or in brief protected field A and protected field B as well as a sequence of protected field intrusions in the signals OSSD A and OSSD B associated with protected fields A and B in the lower part with a vehicle 42 approaching a machine 40 to be safeguarded or its work zone 44. A safe distinction of the vehicle 42 from an approaching person and an automatic restart function are made possible by the special protected field configuration when the vehicle 42 has again departed from the environment of the machine 40. In this respect, the shown protected field configuration is only an example by which this is made possible; a large number of alternatives are possible in accordance with the explanations presented here. The shown protected field configuration is preferably monitored from a perspective from above, but this is also exemplary.

The term protected field has a broad meaning. It is a three-dimensional monitoring geometry that may be assembled from a plurality of likewise three-dimensional partial protected fields that can have different dimensions and shapes and do not have to contact one another. Very complex geometrical structures that can be tailored to applications can thereby be prepared. Due to the combination of partial protected fields to form one protected field, the same protected field intrusion is triggered as soon as an object penetrates somewhere into the protected field. A characteristic time pulse pattern, that is illustrated at the bottom in FIG. 3 for the two shown protected fields A and B at the associated safe signal OSSD A and B and that clearly differs from the pulse pattern of driving off in the opposite direction of travel, results on an approach of the vehicle 42 due to the geometrical design of the protected fields. The approach status of the vehicle 42 can be read at any time using this pulse pattern at the sequence of the protected field intrusions that are expressed in pulse form in the safe signals OSSD A and OSSD B.

The protected fields are configured such that a lower layer and an upper layer result that differ from one another in their protected field geometries. The vehicle 42 is a logistics vehicle, for example, and is considerably lower than an upright person. The still permitted height of the vehicle 42 corresponds to the height of the lower layer or to the height of a dividing plane between the layers. The vehicle 42 then only infringes protected fields in the lower layer on the approach, while an approaching person walking upright inevitably also penetrates into protected fields of the upper layer.

In this example, the protected fields A and B in the lower layer are configured such that partial protected fields alternate and overlap with one another pairwise, with a respective free zone following. When the vehicle 42 approaches that drives on the floor 48 and through the lower layer, protected field A is first infringed, then additionally protected field B, then only protected field A, and then no protected field in the free zone 46. This is repeated a second time with the two left partial protected fields disposed closer to the machine 40. This expected sequence of protected field intrusions can be clearly recognized in the safe output signals shown at the bottom in FIG. 3. In this respect, the overlap delivers an additional consistency condition. The intermediate state in which both protected fields A and B are infringed, always permits an intermediate reversal of direction to be distinguished from a continued movement.

The free zone 46 directly in front of the machine 40 has been reached at the arrow 50. A protected field switchover, that will be explained below with reference to FIG. 5, preferably takes place here. If the vehicle 42 later continues to move from the machine 40 in the reverse direction of movement again, the phasings in the safe output signals reverse. The direction of movement can thus be clearly and safely distinguished. An at least rough position within the approach movement can be determined by counting the pulses or pulse groups, here, for instance, in the classes “at the robot”, “in the intermediate zone”, and “outside the hazardous zone”. The evaluation of the pulses with respect to their binary logic and time sequence can take place in the safety controller 36 that can then generate corresponding switchover signals for protected fields and safeguarding signals and restart signals for the machine 40.

The pulse sequences that arise due to the sequence of protected field intrusions correspond to the scan signals of an incremental encoder. This idea should be looked at in a little more depth. An incremental encoder serves to measure a linear movement or a rotational movement in discrete steps. It uses two separate code tracks for this purpose having incremental code elements that each generate a binary periodic signal on a movement. The signals of both code tracks are phase shifted with respect to one another, which makes the determination of the direction of movement possible. The principle can be transferred to a position determination during the approach to the machine 40. With an incremental encoder, the scan of a respective code element generates a pulse in the scan signal. This is fully analogous to the pulse sequences shown in FIG. 3.

Two respective mutually overlapping partial protected fields can accordingly be understood as a code element of two incremental code tracks, with the code track being able to be extended and refined by a refining of the alternating arrangement in the lower layer in accordance with FIG. 3. A counter is counted up or down corresponding to the direction of movement recognized from the sequence with every pule or double pulse. The count can be evaluated in position classes as above or can be converted into a position using the specific protected field geometry. The code tracks in the example shown are not only very simple because there are effectively only two code elements, but also due to the regular, similar, alternating, and overlapping partial protected fields. A large number of different encodings and evaluations are known from incremental encoders. Such code tracks can be imitated with partial protected fields and the evaluation process of the incremental encoder can then be applied to the corresponding signals at the OSSDs. This in particular relates to the accuracy of the position robustness of the evaluation. Let a debouncing of the switchover be named as an example. On a bouncing, an object is located at a protected field boundary and repeatedly triggers the protected field by small movements. A possibility of debouncing comprises requiring a protected field intrusion into the protected field B having to take place after a protected field intrusion into protected field A, and vice versa, otherwise the protected field intrusion is ignored. However, incremental encoders also know more complex processes for debouncing.

Since the protected field evaluation and the signals at the OSSDs are already reliable in the sense of functional safety, only the simple evaluation of the sequence of protected field infringements and, if a position evaluation is desired, a counter evaluation using the specifications of functional safety have to be implemented. A safety controller 36 having a very moderate power is already sufficient for this purpose. This is a great advantage because such an implementation is possible practically without any development work with existing hardware.

FIG. 4 shows a schematic representation of the protected field configuration in accordance with FIG. 3, now with the protected field intrusions with an approaching person 52. A different sequence of protected field intrusions results due to the different design of the protected fields in the upper layer. Protected field B is permanently infringed; a permanent LOW status at OSSD B results from this and not the characteristic pulse sequence of FIG. 3 with an approaching vehicle 42. Unlike the vehicle 52, the approach to the machine 40 is not permitted to the person 52. The machine 40 is safeguarded. The safe output signal OSSD A here takes the same course as for a vehicle, which only takes place when the zones visible in FIG. 4 are exclusively occupied by the protected field A. To avoid masking, the demand can apply of configuring protected field A, differing from the representation, likewise in the upper layer overlapping with protected field B. Accordingly, OSSD B would then extend exactly as OSSD A. This does not change the fact that the approaching person 52 generates a significantly different sequence of safe output signals than an approaching vehicle 42 and is therefore only a further example for the very large freedom of configuring protected fields in the upper and lower layers and of implementing the idea of the invention in so doing.

It would be possible in principle to avoid the upper layer of the protected fields in that the person 52 moves by crawling. This is a less probable form of manipulation due to the extremely uncomfortable motion and the non-visible protected fields. For additional crawl-under protection, one of the free zones 46 can be configured as so small that a crawling person does not fit. This can relate not only to the direction of approach shown, but also to the transverse direction perpendicular to the plane of the paper.

The protected field configuration in the upper layer has been kept very simple in FIG. 4. This is sufficient for safeguarding against an approaching person 52. More complex protected fields are nevertheless also conceivable in the upper layer. A position determination can in particular thereby or in interaction with both layers also be implemented for an approaching person 52, preferably analogously to an incremental encoder such as was explained with reference to FIG. 3 for a vehicle 52 in the lower layer. Differentiated safeguarding thereby becomes possible, for example, as initially only a deceleration of the machine 40 as long as a person 52 still keeps a certain distance or a successive deceleration up to a standstill with a continued approach.

FIG. 5 shows a schematic representation of the protected field configuration in accordance with FIG. 3 when the vehicle 42 has reached the machine 40. This can be recognized from the sequence of the protected field intrusions; the corresponding point in the pulse sequences is marked by the arrow 50 at the bottom in FIG. 3. A switchover to a different protected field configuration is preferably made in this situation simply because otherwise, on a cooperation between the machine 40 and the vehicle 42, a protected field intrusion of the machine 40 would take place that would not differ from a person 52 penetrating at the other side.

FIG. 6 shows a representation of an exemplary protected field configuration after the switchover. A common workstep of the machine 40 and of the vehicle 42 is hereby safeguarded, in particular a loading or unloading procedure. Access from outside is temporarily fully blocked, the work zone for the machine 40 has been expanded. When the vehicle 42 moves away from the machine 40 again, protected field B is first infringed and this triggers a repeat switchover of the protected field configuration, preferably a switch back to the original protected field configuration. With the protected field configuration shown in FIG. 6, the driving away of the vehicle 42 can be distinguished from the case that a person 52 who has namely first infringed protected field A approaches from the other side. It is safely determined by the evaluation of the sequence of protected field intrusions described with respect to FIG. 3 on a driving away of the vehicle 42 when the vehicle 42 has departed from the hazardous zone and this can be used to initiate an automatic restart of the machine 40. The protected field configuration prevents a person 52 from possibly remaining in the proximity of the machan 40, for instance by climbing onto an elevated structure. It can therefore be safely determined whether a person 52 would still be at risk and the requirements for an automatic restart are therefore satisfied without the requirement of a manual release.

The protected field configuration of FIGS. 3 to 6 have been used to explain embodiments of the invention. This is only to be understood as an example, a large number of variation possibilities have already been named. FIGS. 7 and 8 show two of a very large number of possibilities to also design the protected fields in the previously not considered direction transversely to the movement of approach. This preferably relates to the lower layer, but can also relate to or include the upper layer.

FIG. 7 shows a simplified representation of a protected field configuration with a plurality of corridors arranged next to one another. The protected fields do not only alternate in the direction of the movement of approach, but also transversely thereto. A vehicle 42 approaching from the left here triggers the sequence ABAB; a vehicle 42 approaching from the right, in contrast, triggers the sequence BABA, while a vehicle in the middle having the sequence AB AB AB AB infringes both respective protected fields. Different work zones 54a-b are accordingly driven to. This makes possible a continued working of the machine 40 in the work zone 54a-b respectively not driven to, even with a possible deceleration when there is a person 52 in the other work zone 54a-b. It is conceivable to position a kind of virtual wall by a protected field or a partial protected field between the work zones 54a-b from the start or after a protected field switchover on completion of the approach.

FIG. 8 shows a simplified representation of a further protected field configuration with a switchover to a different protected field set on reaching the machine 40 and two work zones 54a-b monitored by different protected fields. After completion of the approach recognized by the protected field set I, a switchover to a protected field set Il is made by which it is determined whether the vehicle 42 or the person 52 that or who has reached the machine 40 is on the right or on the left. The machine 40 can continue to work on the other side and can maintain production.

The further conceivable protected field configurations first include mixed forms of the shown and explained protected field configurations, for example the combination of corridors in accordance with FIG. 7 with a switchover to the protected field set II in accordance with FIG. 8. A particularly advantageous constellation provides expanding the idea of a position determination analog to an incremental encoder to the transverse direction and thus a two-dimensional position determination in that a grid of protected fields alternating in both directions is formed.

FIGS. 9 and 10 illustrate a still different embodiment. A movement of approach is so-to-say pursued in this respect by a repeat displacement of protected fields. This is an alternative to the alternating, overlapping protected fields or partial protected fields analogously to an incremental encoder. The displacement is preferably implemented by switching over to offset protected fields. FIG. 9 shows this first for an individual switchover step in three different stages. In this respect, only two partial protected fields are shown in a simplified form; this is then continued periodically subsequently with FIG. 10 with a plurality of such partial protected fields.

A vehicle 42 is located between two partial protected fields of the protected fields 38A-B at the left in FIG. 9 at a time t=t₀. A counter for the position is in a status n. The two partial protected fields belong to different protected fields 38A-B to be able to distinguish between a forward and backward movement. In the middle of

FIG. 9, the vehicle 42 has moved forward into the partial protected field of protected field 38A at a time t=t0+dt. The counter for the position is correspondingly counted up to n+1. At the right in FIG. 9, the protected fields are thereupon switched over to a different configuration in which the partial protected fields are upwardly displaced slightly offset. The protected field infringement is thereby canceled. On a continued movement, the protected field 38A is again infringed for the forward movement, the counter is counted up to n+2, and a switchover is again made to a slightly upwardly offset protected field set. On a respective backward movement that is recognized with reference to the infringement of protected field 38B instead of protected field 38A, a correspondingly reverse protected field switchover takes place with a downwardly offset protected field set and the counter for the position is counted down by one.

FIG. 10 shows a schematic representation of four exemplary protected field sets between which there is a cyclic switchover on an object movement to implement the displacement in accordance with FIG. 9. In these protected field sets, the extent in the monitored direction of movement is respectively the same for the partial protected fields and the gaps therebetween and the offset takes place by half of this common extent. The cycle is thereby closed after four switchovers, with optionally the roles for forward and backward, i.e. protected fields A and B, being able to be switched on the switchover between the first and last protected field sets at the end of a cycle. The representation of FIG. 10 is exemplary; a large number of alternative protected field sets are conceivable by which a counter for the position and thus a safe tracking of the movement of approach can be implemented by an automatic switchover to slightly offset partial protected fields.

FIG. 11 shows a schematic representation of a further protected field configuration in which a switchover is made to another protected field set depending on the load state of the vehicle 42. This is an example for the case that it may be sensible independently of a displacement as in FIGS. 9 and 10 to store more than two protected field sets and to switch over between them. In this case, the height of the lower layer or of the dividing plane between the layers is displaced by at least one further protected field set to take account of progressively rising or falling material load states of the vehicle 42. The monitoring volume can thus safeguard the zone around the loaded vehicle 42 in as gapfree a manner as possible in each case in dependence on the height of the vehicle 42 effectively varying by the material 56.

The safety level reached in accordance with the invention first has a dependency on a safety level of the camera 10 that is still representative of an optoelectronic sensor used in accordance with the invention. If the camera, for example, only reaches the safety level SIL 1/PL c, the solution in accordance with the invention is also restricted to applications whose risk assessment has shown that a risk reduction with a performance level c and SIL 1 is sufficient. The safety level can, however, be raised by using an additional camera and thus two cameras 10a-b as in FIG. 2. A camera 10a then, for example, monitors the one protected field A and the other camera 10b monitors the other protected field B or, with more complex protected field configurations, a different distribution over even more cameras also takes place. In the named example, it is not the case that, as previously, two protected fields are simultaneously monitored by a single camera 10, but each camera 10a-b only generates a pulse sequence OSSD A or OSSD B corresponding to the protected field intrusions in that protected field A or b for which the camera 10a-b is responsible. The full pulse sequence is therefore only produced when both cameras 10a-b function properly. A higher safety level can thus be claimed by this redundancy and mutual coupling of the signals in accordance with IEC/TS 62998-1, for example performance level d for the application as a whole despite only a performance level c certified for the individual camera 10a-b. The invention can thus also be used very generally in applications from which a high risk emanates. The upgrade is in particular of very great importance for use on larger robots or other machines having a higher hazard potential. In addition, the central perspective of an individually used camera can be circumvented depending on the arrangement of the two cameras of the same design. Even more complex or smaller partial protected fields can also be effectively monitored by the combination of the safe output signals.

1. A method of a contactless safeguarding of a machine in which a plurality of protected fields configured in the environment of the machine are monitored for protected field intrusions by at least one optoelectronic sensor and, on a protected field intrusion, a safe output signal is generated at a safe output that is associated with the protected field,
wherein the protected fields are configured such that a vehicle approaching the machine results in a different sequence of protected field intrusions than a person approaching the machine and the sequence of protected field intrusions is evaluated to distinguish a vehicle and a person from one another,
wherein the optoelectronic sensor monitors three-dimensional protected fields; wherein the protected fields have at least two layers, having a lower layer and an upper layer arranged thereabove; and wherein the configuration of the protected fields in the lower layer differs from the configuration of the protected fields in the upper layer.

2. The method in accordance with claim 1,
wherein the machine is safeguarded on a recognition of a person approaching the machine.

3. The method in accordance with claim 1,
wherein only two protected fields are monitored.

4. The method in accordance with claim 3,
wherein the only two protected fields are monitored that have partial protected fields.

5. The method in accordance with claim 3,
wherein the two protected fields are monitored for protected field intrusions by a respective one separate optoelectronic sensor.

6. The method in accordance with claim 1,
wherein the protected fields are configured such that on an approach of an object in the lower layer, initially a different protected field is first infringed than in the upper layer.

7. The method in accordance with claim 1,
wherein only one protected field is configured in the upper layer.

8. The method in accordance with claim 7,
wherein the only one protected field is configured in the upper layer without partial protected fields.

9. The method in accordance with claim 1,
wherein two protected fields or partial protected fields of the two protected fields are configured in the lower layer such that the two protected fields or partial protected fields alternate with one another in a direction of an approach to the machine.

10. The method in accordance with claim 9,
wherein the alternating protected fields or partial protected fields partially overlap one another and/or a respective free zone being arranged between the alternating protected fields or partial protected fields.

11. The method in accordance with claim 1,
wherein a plurality of protected fields or partial protected fields are configured in a direction transversely to a direction of an approach of the machine in the lower layer.

12. The method in accordance with claim 1,
wherein at least one free zone between the protected fields or partial protected fields of the protected fields of the lower layer is so small in its lateral extent that a lying or crawling person does not fully have space therein.

13. The method in accordance with claim 1,
wherein a direction of movement is determined from the sequence of protected field intrusions.

14. The method in accordance with claim 13,
wherein a counter is provided and a position is determined from a status of the counter.

15. The method in accordance with claim 14,
wherein the counter is counted up and down on a protected field intrusion or on an ending protected field intrusion corresponding to the direction of movement.

16. The method in accordance with claim 1,
wherein the protected fields are displaced along a direction of approach to the machine after a protected field intrusion in the lower layer.

17. The method in accordance with claim 16,
wherein the protected fields are displaced by a switchover to a protected field configuration with an offset arrangement of the protected fields.

18. The method in accordance with claim 1,
wherein, when a vehicle is at the machine, a switchover to protected fields is made that safeguard the machine and do not permit any further vehicle in the vicinity of the machine.

19. The method in accordance with claim 1,
wherein the machine restarts automatically if no protected field intrusion is present and it was recognized with reference to the preceding sequence of protected field intrusions that a vehicle or a person has departed from the zone of the protected fields.

20. The method in accordance with claim 1,
wherein a height of the lower layer is adapted in dependence on an expected vehicle or on a load state of a vehicle.

21. A monitoring device for a contactless safeguarding of a machine having at least one safe optoelectronic sensor, and a safety controller connected to the optoelectronic sensor, wherein the optoelectronic sensor has a light receiver, at least one safe output, and a control and evaluation unit that is configured to monitor a plurality of protected fields configured in the environment of the machine with reference to the received signal for protected field infringements and to generate a safe output signal at the safety output on a protected field infringement that is associated with the protected field, with the protected fields being configured such that a vehicle approaching the machine produce a different sequence of protected field intrusions than a person approaching the machine, and
wherein the safety controller is configured to evaluate the sequence of protected field intrusions to distinguish the vehicle and the person from one another,
wherein the optoelectronic sensor is configured for monitoring three-dimensional protected fields; wherein the protected fields have at least two layers, having a lower layer and an upper layer arranged thereabove; and wherein the configuration of the protected fields in the lower layer differs from the configuration of the protected fields in the upper layer.

22. The monitoring device according to claim 21, wherein the at least one safe optoelectronic sensor is a 3D camera.
